(19) United States
(12) Patent Application Publication
(10) Pub. No.: US 2012/0206422 A1
(43) Pub. Date: Aug. 16, 2012

(54) PROJECTION DEVICE WITH DISPLAY CONTROL FUNCTION AND METHOD THEREOF

(75) Inventors: CHUNG-JEN WANG, Tu-Cheng (TW); LI-SHENG SHU, Shenzhen City (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/154,454

(22) Filed: Jun. 7, 2011

(30) Foreign Application Priority Data
Feb. 14, 2011 (CN) 201110037499.X

(51) Int. Cl. G09G 5/00

(52) U.S. Cl. 345/204

(57) ABSTRACT

A projection device having a display control function which includes a display unit, a lens module, a motor, a motor control module to control the motor to rotate the lens module and a document unit. The document unit scrolls through the content of an opened document according to the orientation of the lens module sensed by a sensor unit to select the content to be displayed, and controls display of the selected content of the opened document on the display unit. The lens module projects the selected content displayed by the display unit. A method having a display control function is also provided.

### BACKGROUND

1. Technical Field

The present disclosure relates to projection devices and, particularly, to a projection device having a display control function and a method thereof.

2. Description of Related Art

Projection devices are widely used for projecting images obtained from an associated device such as a computer. When projecting images from a computer, the images are limited to whatever is currently viewable on the display of the computer. If there are more contents available such as other pages of a document, then a user must use the computer controls to scroll to the other contents, which is inconvenient and counter-productive, particularly in a darkened meeting room.

Therefore, what is needed is a projection device having a display control function to overcome the described limitations.

### BRIEF DESCRIPTION OF THE DRAWINGS

FIG. 1 is a block diagram of the hardware infrastructure of a projection device having a display control function, in accordance with an exemplary embodiment.

FIG. 2 shows a multi-page document file opened by a document unit of the projection device of FIG. 1.

FIG. 3 shows an image file opened by the document unit of the projection device of FIG. 1.

FIG. 4 illustrates scrolling to different views of the image file of FIG. 3 by the document unit of FIG. 3.

FIG. 5 shows two image files being displayed on a display unit of the projection device of FIG. 1.

FIG. 6 shows the two image files of FIG. 5, being adjusted by the projection device of FIG. 1.

FIG. 7 is a block diagram of the hardware infrastructure of a projection device having a display control function, in accordance with another embodiment.

FIG. 8 is a flowchart of a method having the display control function implemented by the projection device of FIG. 1, in accordance with exemplary embodiment.

### DETAILED DESCRIPTION

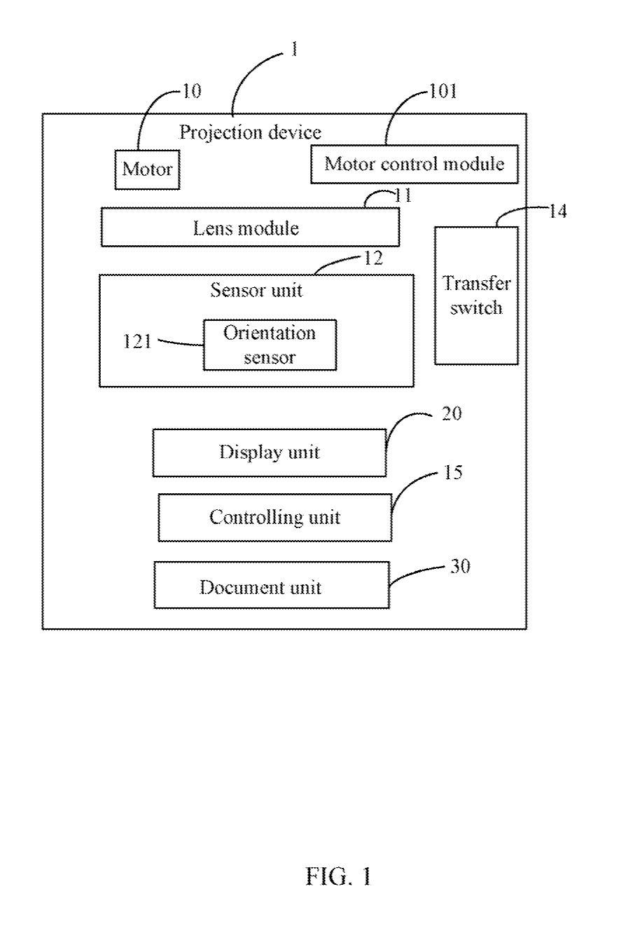

Referring to FIG. 1, a projection device 1 having a display control function is illustrated. The projection device 1 includes a display unit 20, a document unit 30, a lens module 11, a motor 10, and a motor control module 101. The document unit 30 is configured for opening all parts of a document, and selecting the content to display on the display unit 20. In one embodiment, the documents may be PDF files, WORD files, or image files etc. The selected content of the opened document may be content associated with one page of an opened document file, or a portion of an opened image file, etc. The lens module 11 is configured for projecting the selected content onto a projection surface. The motor 10 is configured for controlling the orientation of the lens module 11 and the user can operate the motor control module 101 to control the motor 10. In one embodiment, the motor control module 101 may be a handheld joystick or similar device which can operate reliably in a darkened room.

The projection device 1 further a controlling unit 15. The controlling unit 15 is configured for acquiring a display mode of the content of the opened document and the document unit 30 is further configured for scrolling through the content of the opened document according to an orientation of the lens module 11 sensed by a sensor unit 12 in the display mode provided by the controlling unit 15 to select and re-select the content to be displayed, and to control the display of the selected content of a currently opened document within the display unit 20. In one embodiment, the sensor unit 12 is mounted within the projection device 1, and is configured for sensing the orientation of the lens module 11. In this way, a user operates the motor control module 101 to adjust the lens module 11 to view the other parts of an opened document, which is more convenient than using the control buttons on a computer keyboard.

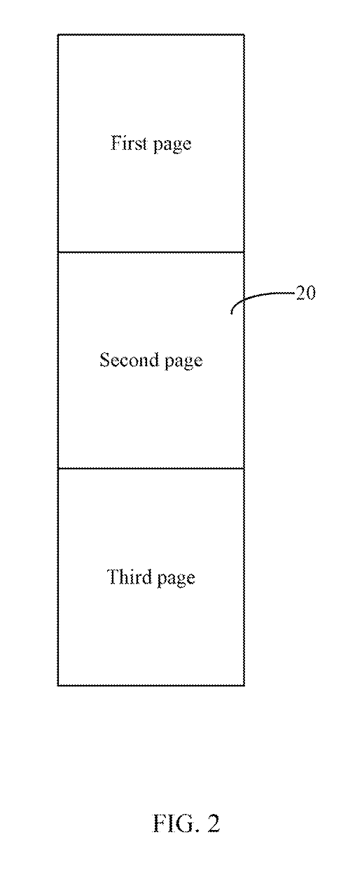

As shown in FIG. 2, in a normal display mode, the document unit 30 opens file A, the display unit 20 displays content associated with a second page of the open file A. When the lens module 11 is rotated by the motor 10, the sensor unit 12 senses the change in orientation of the lens module 11. The document unit 30 scrolls through the open file A towards a previous page (i.e., a first page, for example) according to the orientation of the lens module 11, thereby altering the portion of the projected image of the document.

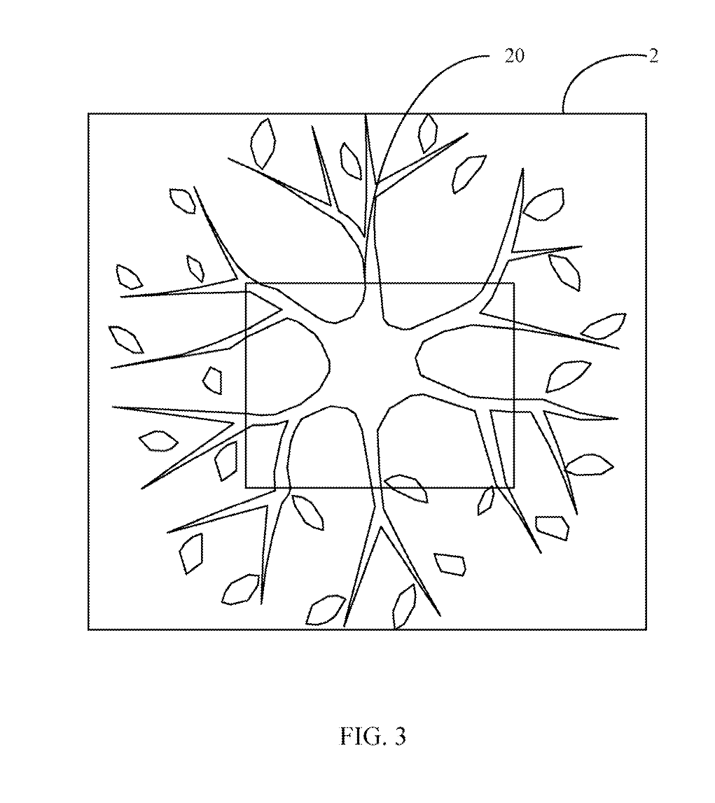

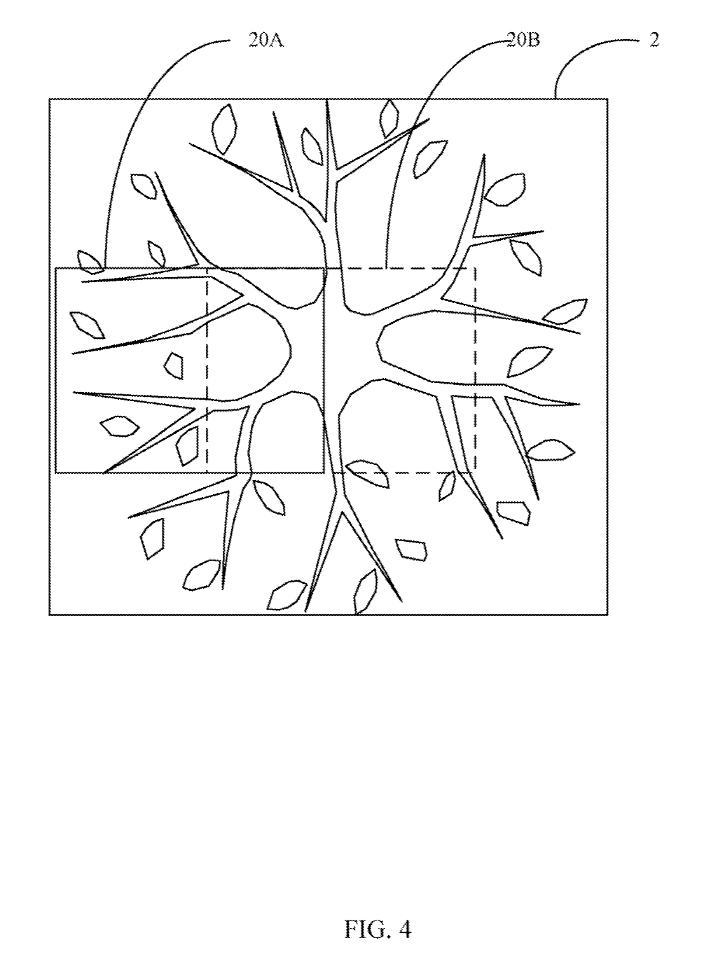

As shown in FIGS. 3-4, in the magnified display mode, due to the large size of an opened image 2, the display unit 20 only displays a portion of the opened image 2, e.g., a portion surrounded by dotted-lines 20B. When the lens module 11 is rotated by the motor 10, the sensor unit 12 senses the change in the orientation of the lens module 11. The document unit 30 scrolls to reveal a surrounded 20A of the image 2, to the left of the portion initially displayed according to the orientation of the lens module 11 as recorded by the sensor unit 12. The portion 20A include a portion associated with or adjacent the portion initially displayed.

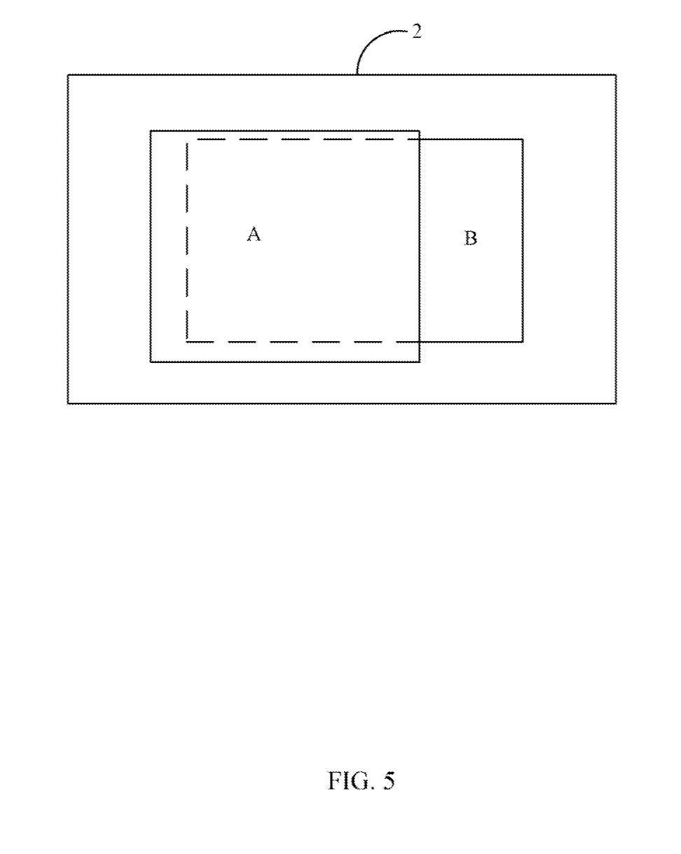

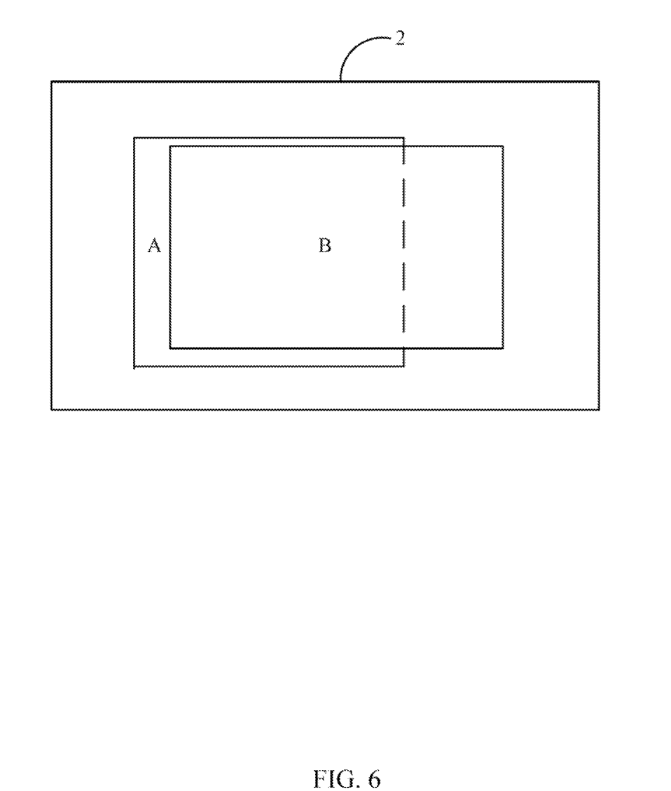

As shown in FIGS. 5-6, in an overlapping display mode, the document unit 30 opens image A and an image B. The display unit 20 displays the image A, and the portion of the image B which overlaps the image A. When the lens module 11 is rotated by the motor 10, the sensor unit 12 senses the orientation of the lens module 11. The document unit 30 scrolls to reveal the portion of the image A which is overlapped by the image B according to the orientation of the lens module 11 sensed by the sensor unit 12.

The sensor unit 12 includes an orientation sensor 121. The orientation sensor 121 is able to sense the orientation of the lens module 11. In one embodiment, the orientation sensor 121 is an electronic compass.

In another embodiment, the projection device 1 further includes a transfer switch 14 which switches the sensor unit 12 between an enabled state and a disabled state. For example, when the user does not want the image, or portion of an image, to be projected according to the sensed rotation of the lens module 11, the user can disable the sensor unit 12 by means of the transfer switch 14.

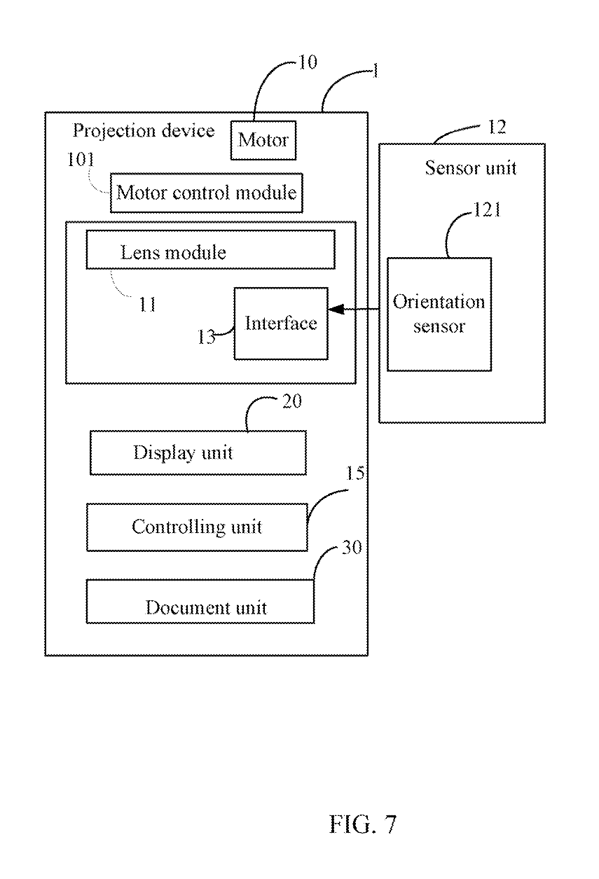

As shown in FIG. 7, in a second embodiment of the disclosure, the projection device 1 further includes an interface 13. The sensor unit 12 can be an independent sensor, which is connected to the projection device 1 through the interface 13.

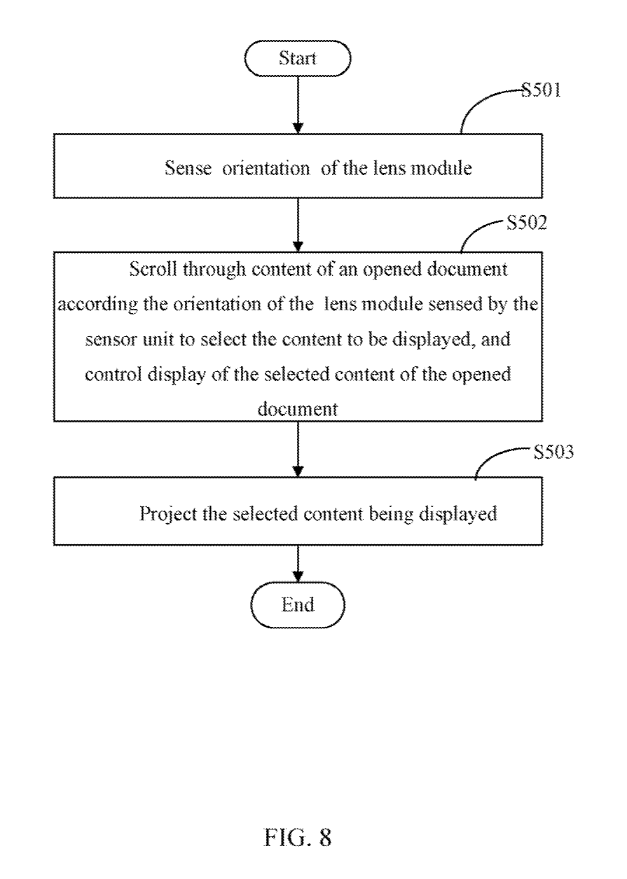

FIG. 8 is the flowchart of a display controlling method implemented by the projection device of FIG. 1, in accordance with exemplary embodiment.

In step S501, the sensor unit 12 senses the orientation of the lens module 11.

In step S502, the document unit 10 scrolls through the content of an opened document according the orientation of the lens module 11 as sensed by the sensor unit 12, to select the portion or content of the opened document which is to be displayed by the display unit 20.

In step S503, the lens module 11 projects the selected content of the opened document.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A projection device having a display control function, comprising:
a display unit;
a lens module;
a motor;
a motor control module to control the motor to rotate the lens module;
a document unit to scroll through the content of an opened document according to an orientation of the lens module sensed by a sensor unit to select the content to be displayed, and control display of the selected content of the opened document on the display unit; and
the lens module to project the selected content displayed by the display unit.

2. The projection device as described in claim 1, further comprising an interface, wherein the sensor unit is an independent sensor and connected to the projection device through the interface.

3. The projection device as described in claim 1, wherein the sensor unit is mounted within the projection device.

4. The projection device as described in claim 1, wherein the sensor unit comprises an orientation sensor, the orientation sensor is configured to sense the orientation of the lens module.

5. The projection device as described in claim 4, wherein the orientation sensor is an electronic compass.

6. The projection device as described in claim 1, further comprising a transfer switch which switches the sensor unit between an enable state and a disable state.

7. The projection device as described in claim 1, further comprising a controlling unit which is configured to acquire a display mode of the content of the opened document on the display unit, wherein the document unit is further configured to scroll through the content of the opened document according to the orientation of the lens module sensed by the sensor unit in the display mode provided by the controlling unit to select the content to be displayed, and control display of the selected content of the opened document on the display unit.

8. The projection device as described in claim 7, wherein when the display mode of the content of the opened document on the display unit is in a normal display mode, the document unit scrolls to select new content of the opened document according to the orientation of the lens module sensed by the sensor unit, and controls display of the selected new content of the opened document on the display unit.

9. The projection device as described in claim 7, wherein when the display mode of the content of the opened document on the display unit is in a magnified display mode, the document unit scrolls to reveal a portion associated with or adjacent a current portion of the content of the opened document according to the orientation of the lens module sensed by the sensor unit, and controls display of the revealed portion of the content of the opened document on the display unit.

10. The projection device as described in claim 7, wherein when the display mode of the content of the opened document on the display unit is in an overlapping display mode, the document unit scrolls to reveal a portion of the content of the opened document which is overlapped by a portion of the content of another opened document according to the orientation of the lens module sensed by the sensor unit, and controls display of the revealed portion of the content of the opened document on the display unit.

11. A method having a display control function implemented by a projection device, wherein the projection device comprises a lens module, a display unit, a motor, and a motor control module to control the motor to rotate the lens module, the method comprising:
sensing orientation of the lens module;
scrolling through content of an opened document according the sensed orientation of the lens module to select the content to be displayed, and controlling display of the selected content of the opened document; and
projecting the selected content being displayed on the display unit.

12. The method as described in claim 11, further comprising:
acquiring a display mode of the content of the opened document; and
scrolling through the content of the opened document according to the sensed orientation of the lens module in the display mode to select the content to be displayed, and controlling display of the selected content of the opened document on the display unit.

13. The method as described in claim 12, further comprising:
scrolling to select new content of the opened document according to the orientation of the lens module, and controlling display of the selected new content of the opened document when the display mode of the content of the opened document is in a normal display mode.

14. The method as described in claim 12, further comprising:
scrolling to reveal a portion associated with or adjacent a current portion of the content of the opened document according to the orientation of the lens module, and controlling display of a portion of the content of the opened document associated with a currently displayed portion of the content of the opened document when the display mode of the content of the opened document on the display unit is in a magnified display mode.

15. The method as described in claim 12, further comprising:
scrolling to reveal a portion of the content of the opened document which is overlapped by a portion of the content of another opened document according to the orientation of the lens module, and controlling display of a portion of the content of the opened document which is overlapped by a portion of the content of another opened document when the display mode of the content of the opened document on the display unit is in an overlapping display mode.
